(19) United States
(12) Patent Application Publication
(10) Pub. No.: US 2026/0331567 A1
(43) Pub. Date: Oct. 22, 2026

(54) SULFUR DIOXIDE-BASED INORGANIC ELECTROLYTE, NEGATIVE ELECTRODE FOR A RECHARGEABLE LITHIUM BATTERY, AND A RECHARGEABLE LITHIUM BATTERY INCLUDING THE NEGATIVE ELECTRODE

(71) Applicants: HYUNDAI MOTOR COMPANY, Seoul (KR); KIA CORPORATION, Seoul (KR); IUCF-HYU (Industry-University Cooperation Foundation Hanyang University), Seoul (KR)

(72) Inventors: Seongmin Ha, Hwaseong-si (KR); Seungjong Lee, Hwaseong-si (KR); Areum Ha, Hwaseong-si (KR); Jongchan Song, Hwaseong-si (KR); Sangheon Lee, Hwaseong-si (KR); Yunseo Jeoun, Hwaseong-si (KR); Junsik Kim, Seoul (KR); Seung Do Mun, Seoul (KR); Seong Hoon Choi, Seoul (KR); Hansu Kim, Seoul (KR); Jiwhan Lee, Seoul (KR)

(73) Assignees: HYUNDAI MOTOR COMPANY, Seoul (KR); KIA CORPORATION, Seoul (KR); IUCF-HYU (Industry-University Cooperation Foundation Hanyang University), Seoul (KR)

(21) Appl. No.: 19/282,824

(22) Filed: Jul. 28, 2025

(30) Foreign Application Priority Data
Apr. 17, 2025 (KR) 10-2025-0050305

(51) Int. Cl. H01M 10/0562; H01M 4/62; H01M 10/052; H01M 10/0561

(52) U.S. Cl. CPC H01M 10/0562; H01M 4/62; H01M 10/052; H01M 10/0561; H01M 2300/0071; H01M 2300/0085

(57) ABSTRACT

A sulfur dioxide-based inorganic electrolyte is prepared by injecting sulfur dioxide (SO₂) gas into an inorganic mixture. The inorganic mixture includes a lithium chloride (LiCl) powder, an aluminum chloride (AlCl₃) powder, and a bismuth fluoride (BiF₃) powder.

### CROSS-REFERENCE TO RELATED APPLICATION

This application claims priority to and the benefit of Korean Patent Application No. 10-2025-0050305 filed with the Korean Intellectual Property Office on Apr. 17, 2025, the entire contents of which are incorporated herein by reference.

### TECHNICAL FIELD

The present disclosure relates to an inorganic electrolyte based on sulfur dioxide doped with a bismuth compound, a negative electrode for a rechargeable lithium including the same, and a rechargeable lithium battery including the negative electrode.

### BACKGROUND

As rechargeable lithium batteries have been successfully commercialized in various fields ranging from small portable electronic devices such as mobile phones and laptops to medium and large energy storage devices such as electric vehicles, energy storage systems (ESS), and the like, the demand for rechargeable lithium batteries is increasing worldwide.

Currently, commercially available rechargeable lithium batteries use a carbonate-based organic electrolyte, which is flammable and thus causes safety issues such as fire, explosion, and the like.

In order to solve this problem, many studies are being conducted to improve the safety of rechargeable lithium batteries, and among them, a sulfur dioxide-based inorganic electrolyte is drawing much attention due to nonflammablility and high ionic conductivity but forms precipitates on the lithium surface due to a reaction with a lithium metal, resultantly deteriorating battery performance. For example, an inorganic liquid electrolyte composed of LiAlCl₄ and SO₂ is non-flammable but exhibits high ionic conductivity of less than or equal to about 0.1 S/cm and thus may improve the safety of rechargeable lithium batteries but precipitates LiCl on the lithium metal surface due to reactivity with the lithium metal, causing problems such as lithium dendrite growth and the like.

The statements in this Background section merely provide background information related to the present disclosure and may not constitute prior art.

### SUMMARY

In view of the foregoing, an aspect of the present disclosure provides a composition of an electrolyte capable of controlling a composition of a film formed on the lithium surface by adding a bismuth compound to a sulfur dioxide-based inorganic electrolyte. The electrolyte according to an aspect of the present disclosure may have phases other than liquid, such as gel, solid, and the like and thus have excellent compatibility.

In an embodiment, an electrolyte having a composition capable of controlling a composition of a film formed on a surface of lithium by adding a bismuth compound to a sulfur dioxide-based inorganic electrolyte, a negative electrode including the same, and a rechargeable lithium battery are provided.

The present disclosure is to provide a sulfur dioxide-based inorganic electrolyte capable of controlling the composition of a film formed on a the surface of lithium by adding a specific composition of bismuth fluoride to an sulfur dioxide-based inorganic electrolyte, and freely having phases such as a gel and a solid other than a liquid, and a negative electrode and a rechargeable lithium battery including the same.

According to an embodiment, a sulfur dioxide-based inorganic electrolyte is prepared by injecting sulfur dioxide (SO₂) gas into an inorganic mixture. The inorganic mixture may include a lithium chloride (LiCl) powder, an aluminum chloride (AlCl₃) powder, and a bismuth fluoride (BiF₃) powder.

According to another embodiment, a negative electrode for a rechargeable lithium battery may include the sulfur dioxide-based inorganic electrolyte.

According to another embodiment, a rechargeable lithium battery may include the negative electrode for the rechargeable lithium battery.

According to an embodiment of the present disclosure, by controlling an amount of bismuth fluoride (BiF₃), a sulfur dioxide-based inorganic electrolyte having various phases may be secured, and the composition of a film formed on the surface of lithium may be changed, thereby fundamentally preventing the precipitation of LiCl on the surface of lithium metal and the growth of lithium dendrites due to reactivity with lithium metal, which has been a chronic problem of conventional rechargeable lithium batteries.

### BRIEF DESCRIPTION OF THE DRAWINGS

FIG. 1 shows photographs taken immediately after the manufacture of an inorganic electrolyte according to Example 1 (top) and 7 days after the manufacture (bottom) at room temperature.

FIG. 2 shows photographs taken immediately after the manufacture of an inorganic electrolyte according to Example 2 (top) and one day after the manufacture (bottom) at room temperature.

FIG. 3 shows photographs taken immediately after the manufacture of an inorganic electrolyte according to Example 3 (top) and one day after the manufacture (bottom) at room temperature.

FIG. 4 shows photographs taken immediately after the manufacture of an inorganic electrolyte according to Example 4 (top) and one day after the manufacture (bottom) at room temperature.

FIG. 5 shows photographs taken immediately after the manufacture of an inorganic electrolyte according to Comparative Example 1 (top) and one day after the manufacturing (bottom) at room temperature.

FIG. 6A is a graph showing Raman spectroscopy performed before gelation of an inorganic electrolyte according to Example 1.

FIG. 6B is a graph showing Raman spectroscopy performed after gelation of the inorganic electrolyte according to Example 1.

FIGS. 7A to 7C are graphs showing Raman spectroscopy results for the inorganic electrolytes according to Examples 1 and 2 in a gel state, the inorganic electrolytes according to Examples 3 and 4 in a solid state, and the inorganic electrolyte according to Comparative Example 1 in a liquid state, respectively.

FIG. 8 is a graph showing the ionic conductivity of inorganic electrolytes according to Example 1, Example 2, and Comparative Example 1.

FIG. 9 is a graph showing the ionic conductivity of an inorganic electrolyte according to Example 3.

FIGS. 10A and 10B show lithium symmetric cell evaluation data using the inorganic electrolyte according to Example 1 in a gel state, the inorganic electrolyte according to Example 1 in a liquid state, and the inorganic electrolyte according to Comparative Example 1 (in a liquid state), respectively.

FIG. 11 shows lithium symmetric cell evaluation data using an inorganic electrolyte according to Example 2 and an inorganic electrolyte according to Example 3.

FIGS. 12A-12D are graphs showing X-ray photoelectron spectroscopy (XPS) performed on lithium metal after lithium metal was supported on the inorganic electrolyte according to Comparative Example 1, respectively.

FIGS. 13A-13E are graphs showing X-ray photoelectron spectroscopy (XPS) results obtained after lithium metal was supported on an inorganic electrolyte according to Example 1.

FIGS. 14 and 15 are graphs showing lithium symmetric cell evaluations performed on lithium metal after surface pretreatment by coating an inorganic electrolyte according to Example 1 and an inorganic electrolyte according to Comparative Example 1, respectively.

The drawings described herein are for illustration purposes only and are not intended to limit the scope of the present disclosure in any way.

### DETAILED DESCRIPTION

Special terms used herein is for the purpose of describing embodiments only and are not intended to be limiting of the present disclosure. The singular forms used herein include plural forms as well, if the phrases do not clearly have the opposite meaning. The term “including” or “comprising” used in the specification means that a specific feature, region, integer, step, operation, element and/or component is embodied and other specific features, regions, integers, steps, operations, elements, and/or components are not excluded.

Unless defined otherwise, all terms including technical and scientific terms used herein have the same meaning as commonly understood by those having ordinary skill in the art to which the present disclosure belongs. Commonly used predefined terms are further interpreted as having a meaning consistent with the relevant technical literature and the present disclosure, and are not to be construed as ideal or very formal meanings unless defined otherwise.

Terms such as “first,” “second,” “third” and the like are used for describing various arts, components, regions, layers, and/or sections, but are not limited thereto. These terms are only used to distinguish any part, component, region, layer, or section from the other part, component, region, layer, or section. Accordingly, the first part, component, region, layer, or section described below may be mentioned as the second part, component, region, layer, or section within the range without departing from the range of the present disclosure.

Also, unless specifically stated otherwise, % means wt %, and if no unit is specified separately, the unit based on weight is omitted.

As used herein, the term “combination(s) thereof” described in the expression in the Makushi format refers to one or more mixtures or combinations selected from the components described in the expression in the Makushi format, and refers to including at least one selected from the components.

In this specification, “room temperature” may mean 15° C. to 25° C., for example, 15° C. to 20° C., for example, 20° C. to 25° C., for example, 20° C. or 25° C.

Hereinafter, embodiments of the present disclosure are described in detail. However, these embodiments are examples, and this disclosure is not limited thereto.

### Sulfur Dioxide-Based Inorganic Electrolyte

The present disclosure relates to a sulfur dioxide-based inorganic gel electrolyte doped with a bismuth compound and a method for preparing the same. More specifically, the present disclosure relates to a inorganic electrolyte having a composition obtained by mixing lithium chloride (LiCl), aluminum chloride (AlCl₃), and bismuth fluoride (BiF₃) in various compositions and then injecting SO₂ gas, and a method for preparing the same. In the composition, electrolytes of various phases may be secured by controlling the content of bismuth fluoride (BiF₃), and therefore, a rechargeable lithium battery including a negative electrode including the same may be used for various purposes.

The sulfur dioxide-based inorganic electrolyte according to an embodiment of the present disclosure includes a sulfur dioxide-based inorganic electrolyte prepared by injecting sulfur dioxide (SO₂) gas into an inorganic mixture. The inorganic mixture includes a lithium chloride (LiCl) powder, an aluminum chloride (AlCl₃) powder, and a bismuth fluoride (BiF₃) powder.

In an embodiment, the inorganic mixture may be a mixture of the lithium chloride (LiCl) powder, aluminum chloride (AlCl₃) powder, and bismuth fluoride (BiF₃) powder. When the inorganic mixture is composed of (for example, is consisting of) the three types of powders, the composition of the film formed on the surface of lithium may be changed more easily than when the powders are mixed individually or only two types, and further, the phase of the finally prepared inorganic electrolyte may be easily changed simply by controlling an amount of bismuth fluoride. Furthermore, if the inorganic mixture includes other powders in addition to the three types of powders, it may be difficult to easily achieve the above-mentioned effect.

In an embodiment, the “lithium chloride (LiCl) powder” and the “mixture of aluminum chloride (AlCl₃) powder and bismuth fluoride (BiF₃) powder” may have a molar ratio of 1:1. The “lithium chloride (LiCl) powder” and the “mixture of aluminum chloride (AlCl₃) powder and bismuth fluoride (BiF₃) powder” may be mixed in the same molar ratio to maximize or achieve the aforementioned effect.

For example, the lithium chloride (LiCl) powder may be mixed in the greater mole number than each of the aluminum chloride (AlCl₃) powder and the bismuth fluoride (BiF₃) powder. In other words, the lithium chloride (LiCl) powder may be mixed in the larger mole number than the aluminum chloride (AlCl₃) powder, and the lithium chloride (LiCl) powder may be mixed in the larger mole number than the bismuth fluoride (BiF₃) powder. In other words, when mixing, the mole number of the lithium chloride (LiCl) powder is greater than the mole number of the aluminum chloride (AlCl₃) powder, and the mole number of the lithium chloride (LiCl) powder is greater than the mole number of the bismuth fluoride (BiF₃) powder.

For example, the aluminum chloride (AlCl₃) powder may be mixed in a greater mole number than the bismuth fluoride (BiF₃) powder. In other words, in mixing, the mole number of the aluminum chloride (AlCl₃) powder is greater than the mole number of the bismuth fluoride (BiF₃) powder. In order to maximize or achieve the aforementioned effect, the amount of the bismuth fluoride (BiF₃) powder may be controlled by adjusting the mixing molar ratio with the aluminum chloride (AlCl₃) powder, assuming that the “lithium chloride (LiCl) powder” and the “mixture of aluminum chloride (AlCl₃) powder and bismuth fluoride (BiF₃) powder” have a molar ratio of 1:1.

In an embodiment, the aluminum chloride (AlCl₃) powder and the bismuth fluoride (BiF₃) powder may have a molar ratio in a range of 9:1 to 6:4. When the above aluminum chloride (AlCl₃) powder and bismuth fluoride (BiF₃) powder are mixed in the molar ratio in a range of 9:1 to 6:4, the finally prepared inorganic electrolyte may have a liquid, gel, or solid phase at room temperature.

In an embodiment, the aluminum chloride (AlCl₃) powder and the bismuth fluoride (BiF₃) powder may have a molar ratio of 9:1 to 8:2, and at this time, the sulfur dioxide-based inorganic electrolyte may have a liquid or gel phase at room temperature. The sulfur dioxide-based inorganic electrolyte having the above composition (i.e., the aluminum chloride (AlCl₃) powder and the bismuth fluoride (BiF₃) powder having a molar ratio of 9:1 to 8:2) may be prepared as an inorganic electrolyte having a liquid phase at room temperature and then gradually changed into a gel phase over time, or may be prepared directly into a gel phase at room temperature.

In an embodiment, the aluminum chloride (AlCl₃) powder and the bismuth fluoride (BiF₃) powder may have a molar ratio of 7:3 to 6:4, and at this time, the sulfur dioxide-based inorganic electrolyte may have a gel or solid phase at room temperature. The sulfur dioxide-based inorganic electrolyte having the above composition (i.e., the aluminum chloride (AlCl₃) powder and the bismuth fluoride (BiF₃) powder having a molar ratio of 7:3 to 6:4) may be prepared as an inorganic electrolyte having a gel phase at room temperature and then gradually changed into a solid phase over time, or may be prepared into a solid phase directly at room temperature.

The sulfur dioxide-based inorganic electrolyte may have a viscosity of 1 mPa·s to 10⁶ mPa·s at room temperature.

A method for preparing a sulfur dioxide-based inorganic electrolyte according to an embodiment may include injecting sulfur dioxide (SO₂) gas into an inorganic mixture including lithium chloride (LiCl) powder, aluminum chloride (AlCl₃) powder, and bismuth fluoride (BiF₃) powder.

The remaining composition may be as described above.

### Negative Electrode for Rechargeable Lithium Battery and Rechargeable Lithium Battery

According to another embodiment, a negative electrode for a rechargeable lithium battery including the sulfur dioxide-based inorganic electrolyte (or an electrolyte solution including the same) and a rechargeable lithium battery including the negative electrode are provided.

The negative electrode may include a current collector, and the current collector is not particularly limited as long as it is used as a negative electrode current collector of a general rechargeable lithium battery. The current collector may include, for example, copper, stainless steel, aluminum, nickel, titanium, calcined carbon, copper or stainless-steel surface-treated with carbon, nickel, titanium, silver, an aluminum-cadmium alloy, and/or the like. In addition, the current collector may typically have a thickness of 3 μm to 500 μm, and fine unevenness may be formed on the surface of the current collector to strengthen the bonding strength of the negative electrode active material. For example, the current collector may be used in various forms such as a film, a sheet, a foil, a net, a porous body, a foam, a non-woven fabric, and the like.

As described above, a rechargeable lithium battery manufactured using a negative electrode including a sulfur dioxide-based inorganic electrolyte according to an embodiment of the present disclosure may have an excellent cycle-life and excellent electrochemical properties, and therefore may be useful in portable devices such as mobile phones, laptop computers, and digital cameras, and electric vehicles such as hybrid electric vehicles (HEVs).

The following examples illustrate the present disclosure in more detail. However, the following examples are only embodiments of the present disclosure, and the present disclosure is not limited to the following examples.

### Example 1: Preparation of Sulfur Dioxide-Based Inorganic Electrolyte

After physically mixing lithium chloride (LiCl) powder, aluminum chloride (AlCl₃) powder, and bismuth fluoride (BiF₃) powder in a synthesis molar ratio of 1; 0.9:0.1, sulfur dioxide gas (SO₂) was injected into the mixture to prepare a sulfur dioxide (SO₂)-based inorganic electrolyte.

### Example 2: Preparation of Sulfur Dioxide-Based Inorganic Electrolyte

A sulfur dioxide (SO₂)-based inorganic electrolyte was prepared under the same condition as in Example 1 except that the synthesis molar ratio of lithium chloride (LiCl):aluminum chloride (AlCl₃):bismuth fluoride (BiF₃) was changed to 1:0.8:0.2.

### Example 3: Preparation of Sulfur Dioxide-Based Inorganic Electrolyte

A sulfur dioxide (SO₂)-based inorganic electrolyte was prepared under the same condition as in Example 1 except that the synthesis molar ratio of lithium chloride (LiCl):aluminum chloride (AlCl₃):bismuth fluoride (BiF₃) was changed to 1:0.7:0.3.

### Example 4: Preparation of Sulfur Dioxide-Based Inorganic Electrolyte

A sulfur dioxide (SO₂)-based inorganic electrolyte was prepared under the same condition as in Example 1 except that the synthesis molar ratio of lithium chloride (LiCl):aluminum chloride (AlCl₃):bismuth fluoride (BiF₃) was changed to 1:0.6:0.4.

### Comparative Example 1

After physically mixing lithium chloride (LiCl) powder and aluminum chloride (AlCl₃) powder in a synthesis molar ratio of 1:1, sulfur dioxide gas (SO₂) was injected into the mixture to prepare a sulfur dioxide (SO₂)-based inorganic electrolyte. The electrolyte is represented by LiAlCl₄⁻ySO₂ (0<y≤6).

### Evaluation 1: Phase Change

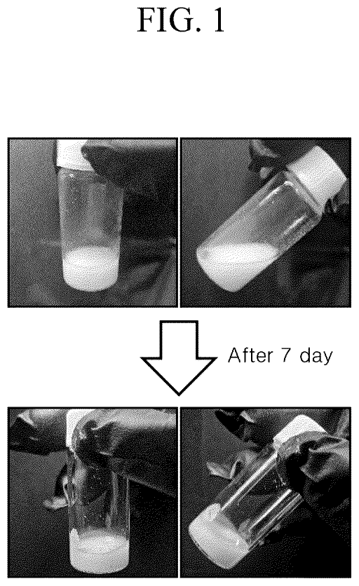

After synthesizing the inorganic electrolytes according to Examples 1 to 4 and Comparative Example 1, it was checked whether each phase immediately after the synthesis changed or not. Immediately after the synthesis, the inorganic electrolytes according to Examples 1 to 4 and Comparative Example 1 were taken an image of and after the phase change, taken another image of, and the results are shown in FIGS. 1 to 5.

Referring to FIG. 1, the electrolyte of Example 1 was in a liquid state immediately after the synthesis but exhibited increased viscosity over time and became a gel after one week.

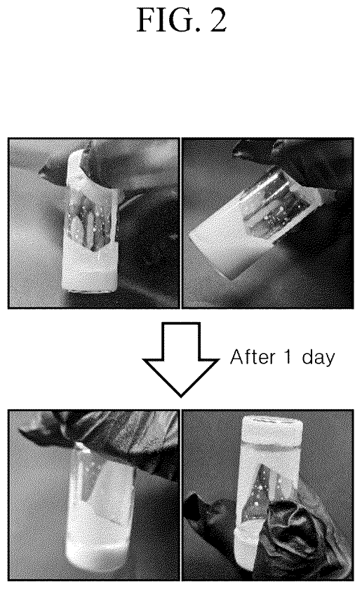

Referring to FIG. 2, the electrolyte of Example 2 was in a liquid state immediately after the synthesis like Example 1 but exhibited no fluidity and became gel after one day.

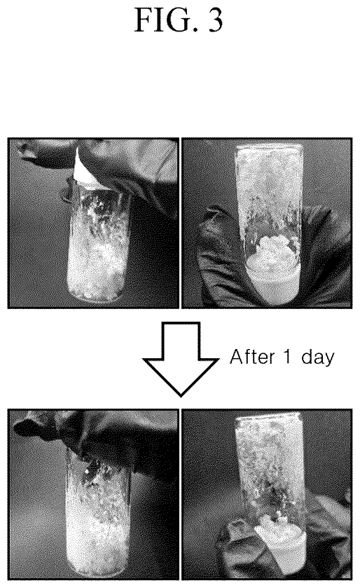

Referring to FIG. 3, the electrolyte of Example 3 was in a gel state immediately after the synthesis but became solid after one day.

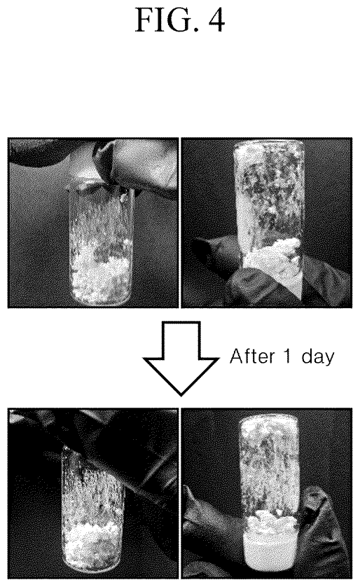

Referring to FIG. 4, the electrolyte of Example 4 was in a gel state immediately after the synthesis like that of Example 3 but became solid after one day.

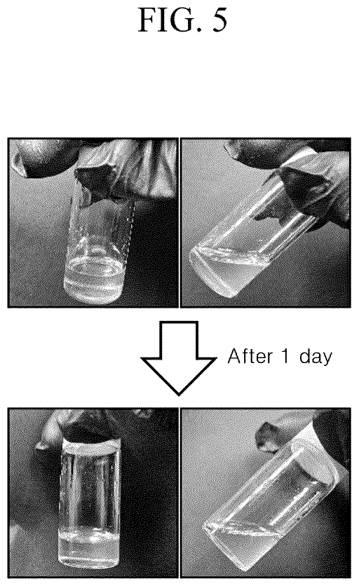

Referring to FIG. 5, the electrolyte of Comparative Example 1 exhibited no phase change.

### Evaluation 2-1: Raman Spectroscopy

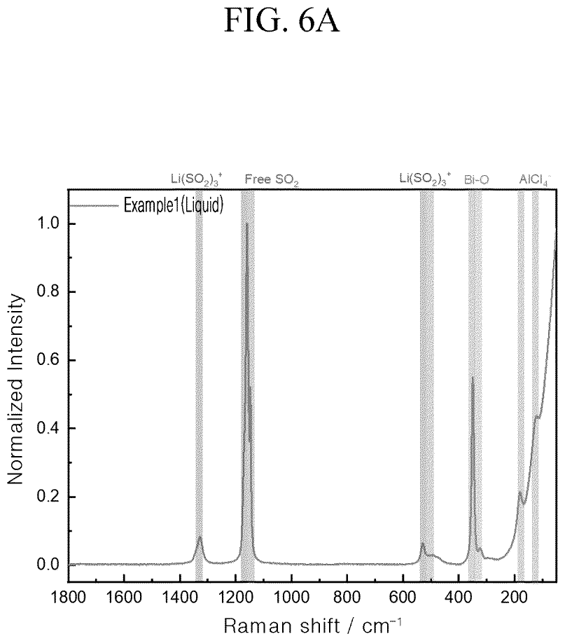

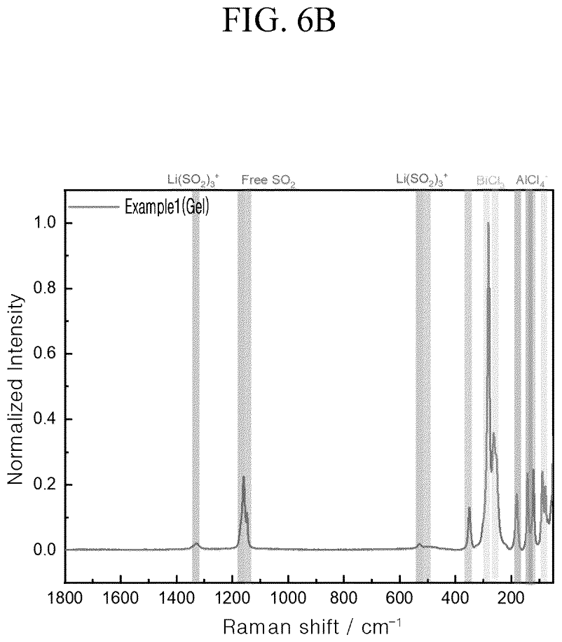

Example 1 was subjected to Raman spectroscopy before and after the gelation, and the result is shown in FIGS. 6A and 6B.

Before the gelation, in addition to Li(SO₂)₃⁺, free SO₂, and AlCl₄⁻ bands, a Bi-0 band was observed around 320 cm⁻¹.

After the gelation, the Li(SO₂)₃+, free SO₂, and AlCl₄⁻ bands exhibited lower intensity than that before the gelation, the Bi—O band disappeared, and a BiCl₃ band was observed around 76, 88, 119, 141, 179, 262, and 280 cm⁻¹.

### Evaluation 2-2: Raman Spectroscopy

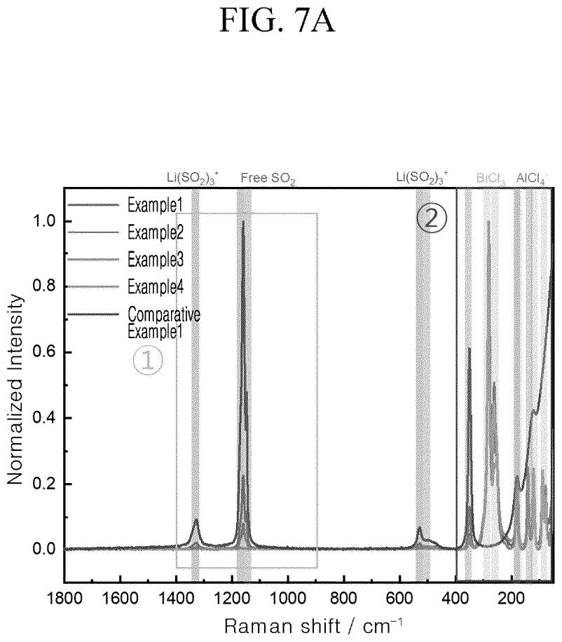

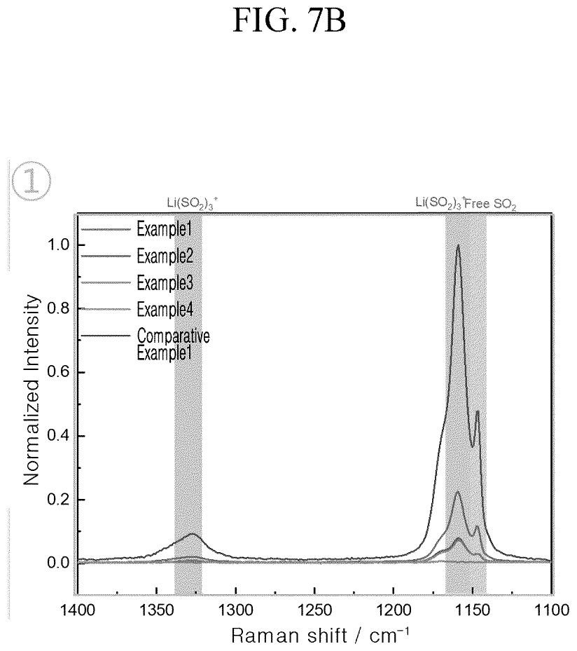

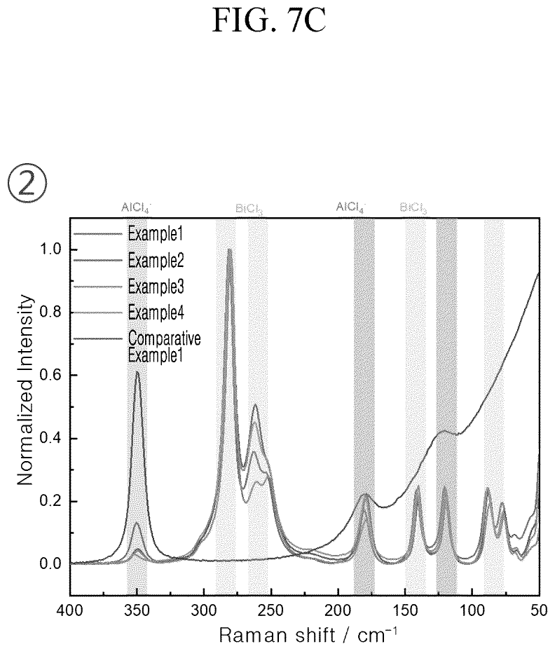

Examples 1, 2, 3, and 4 and Comparative Example 1 were subjected to Raman spectroscopy, and the results are shown in FIGS. 7A-7C.

Examples 1 and 2, which were in a gel state, and Examples 3 and 4, which were in a solid state, were all subjected to Raman spectroscopy analysis.

Commonly, the Li(SO₂)₃⁺, free SO₂, AlCl₄⁻, and BiCl₃ bands were observed.

In Example 1, the Li(SO₂)₃⁺, free SO₂, and AlCl₄⁻ bands exhibited higher intensity than in Examples 2, 3, and 4, wherein the larger amount of the bismuth fluoride (BiF₃) added during the electrolyte synthesis, the lower intensity of the Li(SO₂)₃⁺, free SO₂, and AlCl₄⁻ bands.

### Evaluation 3-1: Measurement of Ionic Conductivity

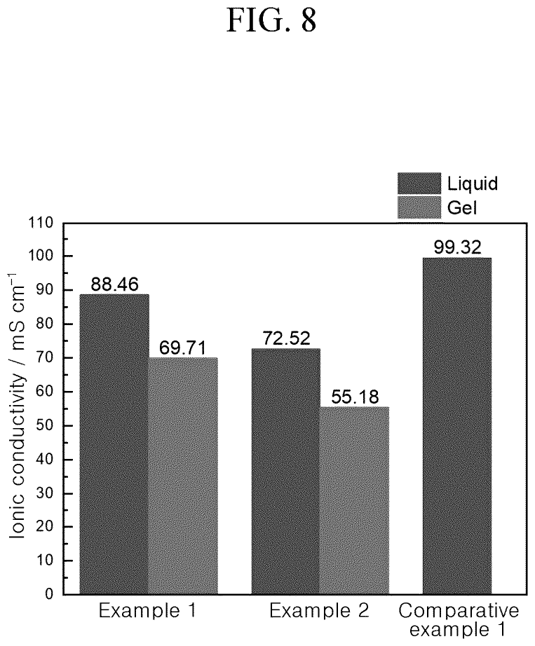

Examples 1 and 2 and Comparative Example 1 were measured with respect to ionic conductivity, and the results are shown in FIG. 8. The ionic conductivity was measured by using a conductivity meter.

Both Examples 1 and 2, which were changed from the liquid state into a gel, were confirmed that the ionic conductivity decreased. Regardless of the gelation, the ionic conductivity of Examples 1 and 2 was lower than that of Comparative Example 1 but higher than that of carbonate-based electrolytes (~10 mS·cm⁻¹).

### Evaluation 3-2: Measurement of Ionic Conductivity

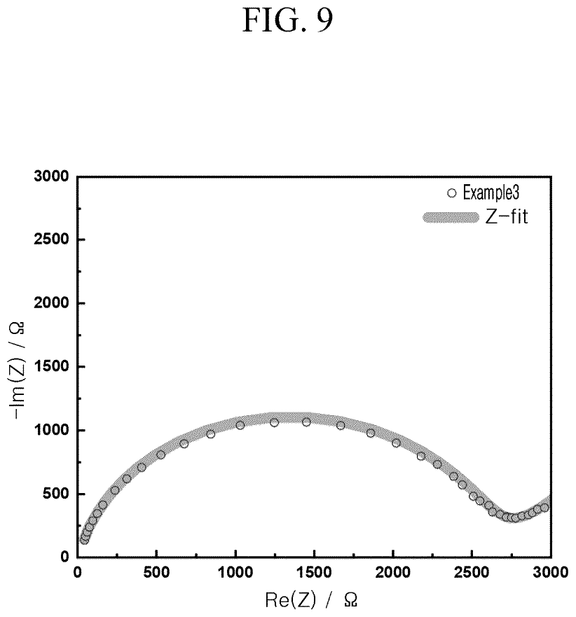

Example 3 was measured with respect to ionic conductivity, and the result is shown in FIG. 9 and Table 1. The powder of Example 3 was ground in a mortar and then, pelletized. Subsequently, the ionic conductivity was measured through electrochemical impedance spectrometry (EIS) by using a pressurized cell. The ionic conductivity measurement was performed according to Equation 1 below.
Working electrode: Pt (platinum) foil
Counter electrode: Pt (platinum) foil
Frequency range: 0.1 Hz to 7 MHz
Amplitude: 5 mV

σ=(1/R)×(I/A) Equation 1:
(σ: Ionic conductivity (S/cm)
I: Distance between electrodes (cm) (=thickness of pellet)
A: Area of electrodes (cm²)
R: Bulk Resistance (Ω))

TABLE 1

| Bulk resistance | Ionic conductivity |
|---|---|
| 2642.12 Ω | 0.037 mS/cm |

The ionic conductivity measurement result was 0.037 mS·cm⁻¹, which was rather low for use as an electrolyte.

### Evaluation 4-1: Evaluation of Lithium Symmetric Cell

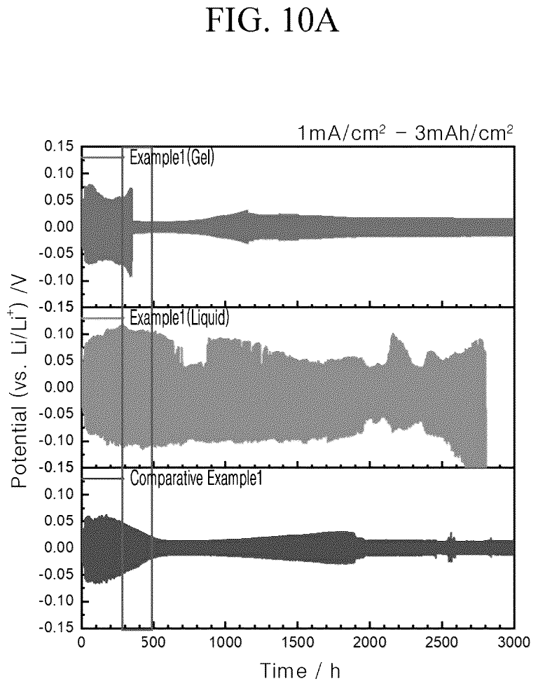

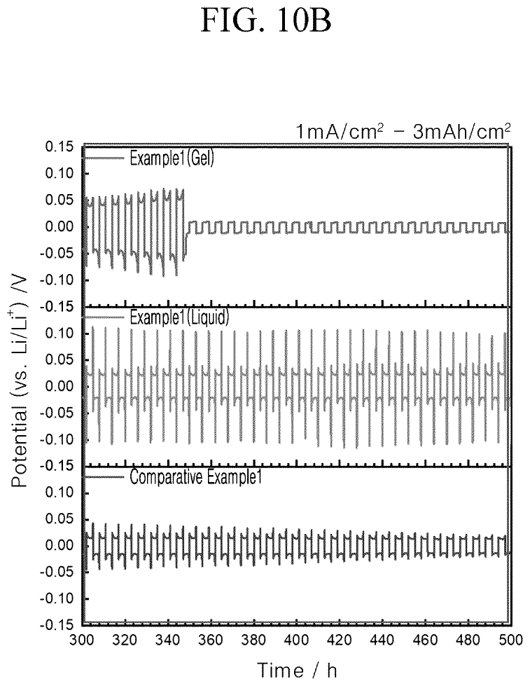

The electrolytes of Example 1 and Comparative Example 1 were respectively used to evaluate lithium symmetric cells, and the results are shown in FIGS. 10A and 10B.

Each coin-type battery (CR 2032) cell was manufactured by using a 200 μm lithium metal foil and a glassy fiber filter (GFF) as a separator. The evaluation was performed at current density-capacity per area of 1 mA·cm⁻²-3 mAh·cm⁻².

Example 1, which was in a liquid state before the gelation, was confirmed that an overvoltage was formed higher than Comparative Example 1.

Example 1 exhibited a similar initial overvoltage after the gelation to that of Comparative Example 1 but was judged that a micro-short circuit occurred after approximately the 55^{th} cycle of operation.

### Evaluation 4-2: Evaluation of Lithium Symmetric Cell

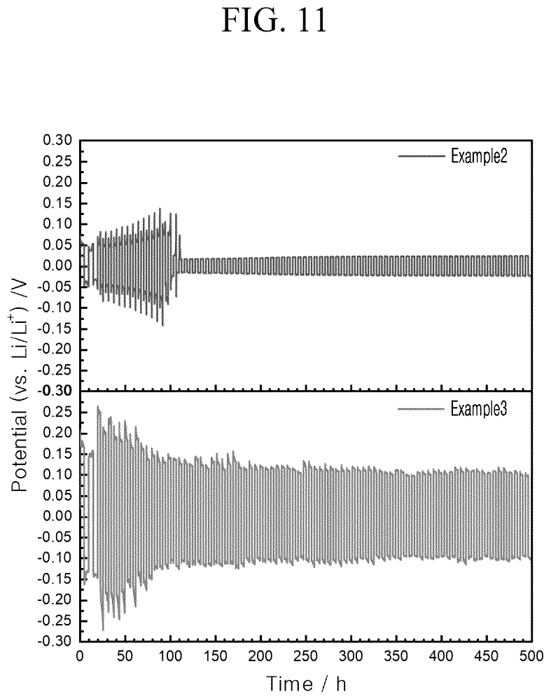

The electrolytes of Examples 2 and 3 were used to evaluate lithium symmetric cells, and the results are shown in FIG. 11.

Example 2 was evaluated under the same condition as that of Example 1.

In Example 3, a pressurized cell was used. The electrolyte was pressurized into a pellet at 375 MPa, and the cell was operated at a pressure of 30 kgf·cm.

Example 2 was confirmed that the overvoltage continuously increased after the operation of the cell, and an internal short circuit occurred after about 100 hours.

Example 3 was confirmed that the overvoltage between charge-discharge was formed very high.

### Evaluation 5-1: X-Ray Photoelectron Spectroscopy (XPS)

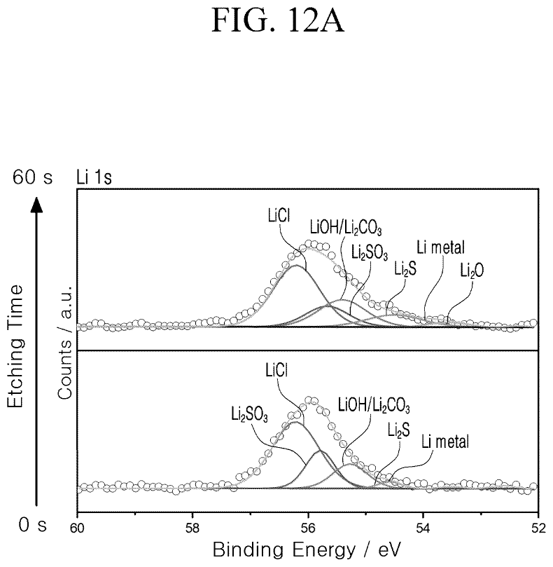

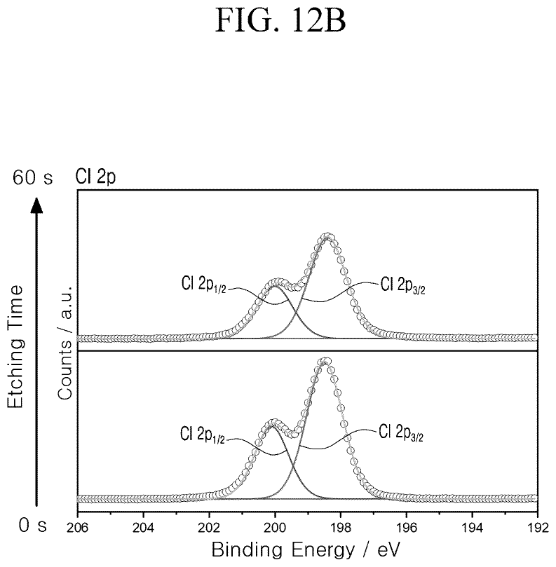

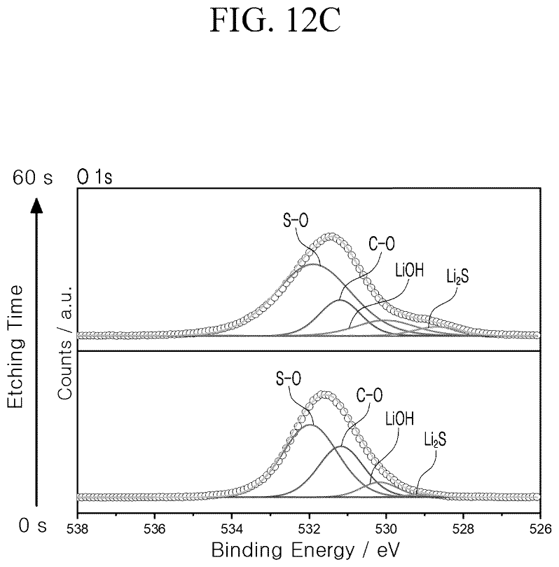

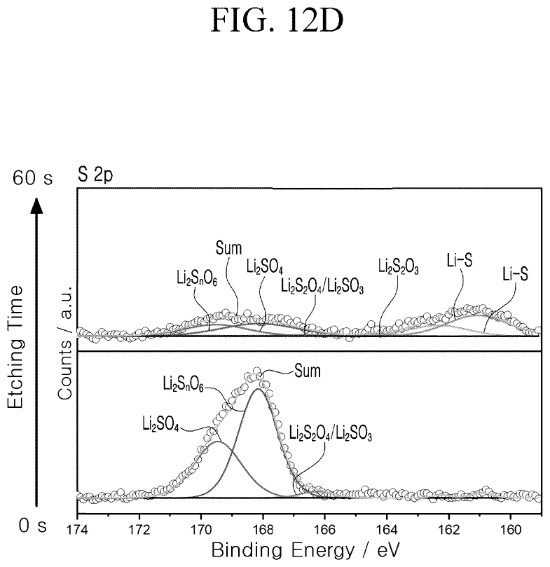

Comparative Example 1, in which a lithium metal was supported for 24 hours, was subjected to X-ray photoelectron spectroscopy (XPS) on the lithium, and the result is shown in FIGS. 12A-12D.

Main components of a thin film formed on the lithium metal surface were confirmed to be LiCl and lithium sulfur-oxy compound (LiₓS_{y}O_{z}; x is 0.5-3, y is 1~6, z is 0.1~1).

After the depth profiling, it was confirmed that intensity of a Li₂O lithium sulfide (Li—S) peak increased.

### Evaluation 5-2: X-Ray Photoelectron Spectroscopy (XPS)

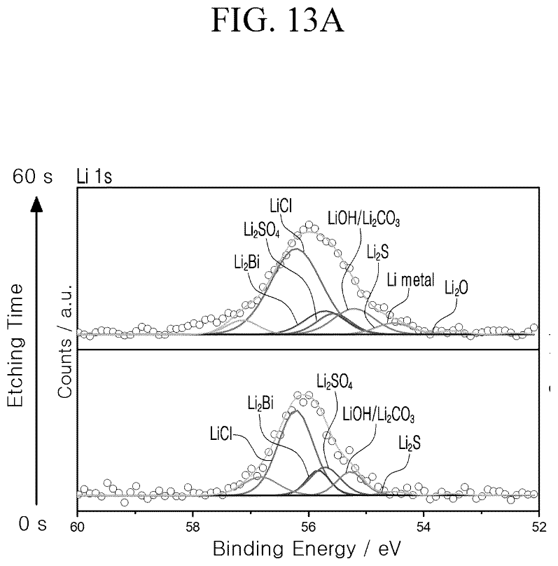

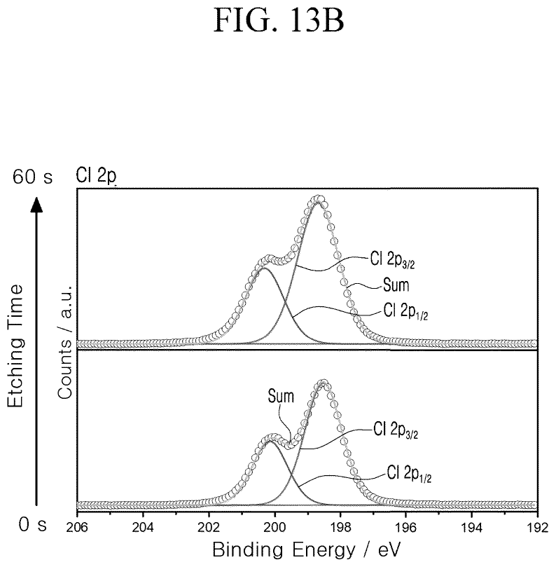

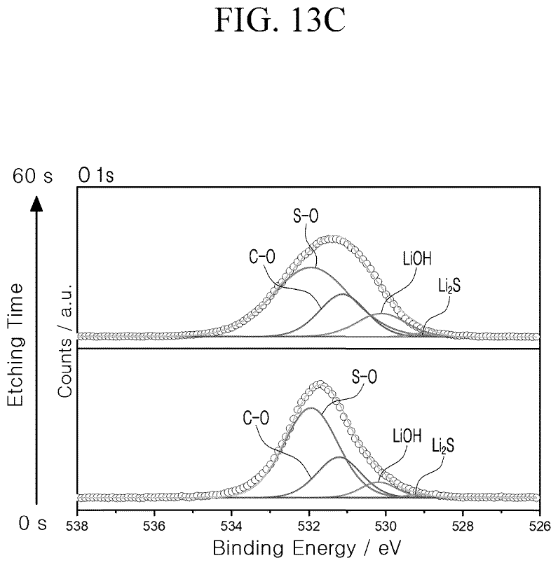

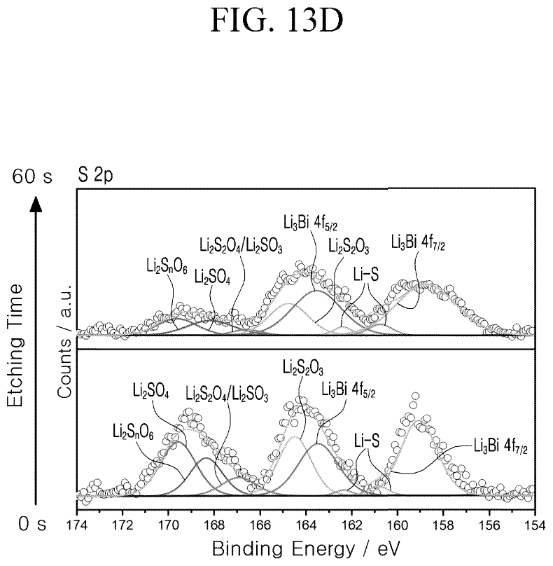

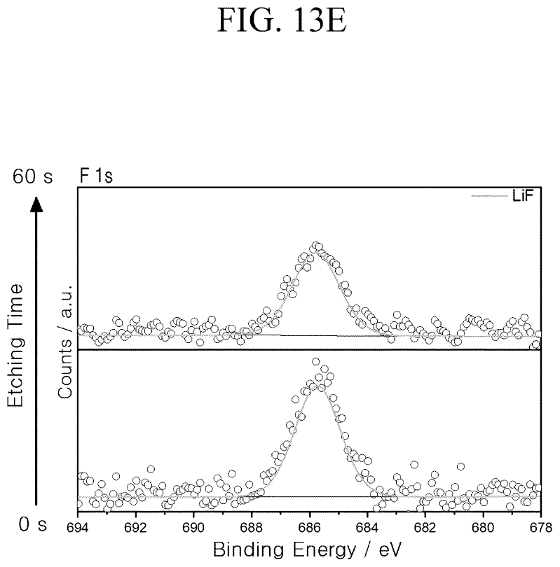

Example 1, in which a lithium metal was supported for 24 hours, was subjected to X-ray photoelectron spectroscopy (XPS), and the result is shown in FIGS. 13A-13E.

Main components of a thin film formed on the lithium metal surface were confirmed to be LiCl and lithium sulfur-oxy compound (LiₓS_{y}O_{z}; x is 0.5-3, y is 1~6, z is 0.1~1).

In addition to them, Li₃Bi and LiF were confirmed on the surface of lithium due to a reaction between lithium and electrolyte.

After the depth profiling, it was confirmed that intensity of LiCl and lithium sulfide (Li—S) peaks increased.

### Evaluation 6: Surface Pretreatment of Lithium Metal and Evaluation of Lithium Symmetric Cell

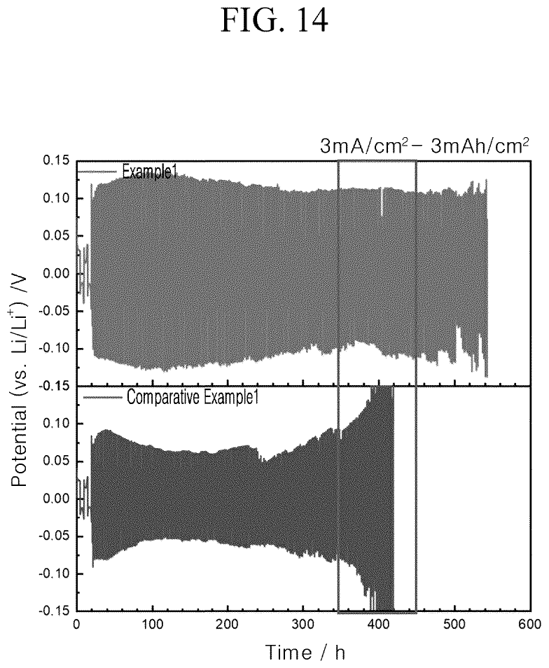

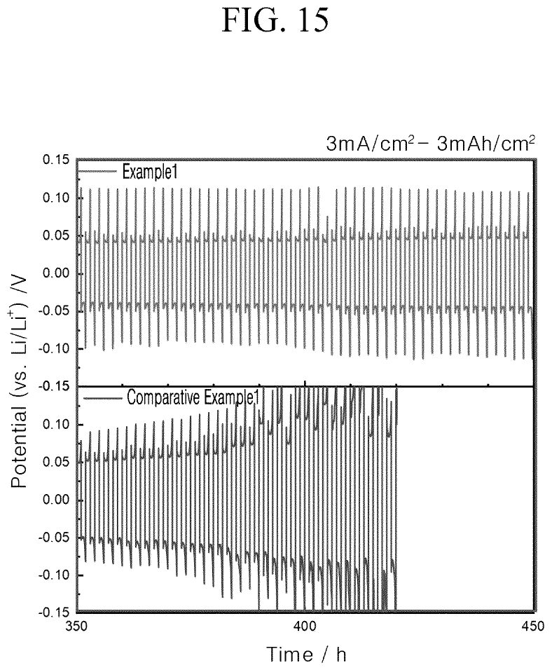

After applying a small amount of Example 1 to a lithium metal to pre-treat the surface, the corresponding lithium was subjected to the lithium symmetric cell evaluation, and the results are shown in FIGS. 14 and 15.

A coin-type battery (CR 2032) cell manufactured by using the lithium metal foil pre-treated by using Example 1 was used. The electrolyte of Comparative Example 1 (LiAlCl₄⁻3SO₂) as an electrolyte and a glassy fiber filter (GFF) as a separator were used. The evaluation was performed at current density-capacity per area of 3 mA·cm⁻²-3 mAh·cm⁻².

Comparative Example 1 was confirmed that the cell operation was stopped at the 202^{nd} cycle due to a high overvoltage exceeding the upper voltage limit.

The lithium surface-pretreated by applying a small amount of Example 1, compared with that of Comparative Example 1, was confirmed to exhibit a high overvoltage at the initial cycles but excellent cycle-life characteristics.

While the present disclosure has been described in connection with what is presently considered to be practical example embodiments, it is to be understood that the present disclosure is not limited to the disclosed embodiments, but, on the contrary, is intended to cover various modifications and equivalent arrangements included within the spirit and scope of the appended claims. Therefore, the aforementioned embodiments should be understood to be examples but not limiting the present disclosure in any way.

What is claimed is:

1. A sulfur dioxide-based inorganic electrolyte, wherein
the sulfur dioxide-based inorganic electrolyte is prepared by injecting sulfur dioxide (SO₂) gas into an inorganic mixture,
wherein the inorganic mixture comprises:
a lithium chloride (LiCl) powder;
an aluminum chloride (AlCl₃) powder; and
a bismuth fluoride (BiF₃) powder.

2. The sulfur dioxide-based inorganic electrolyte of claim 1, wherein the inorganic mixture is a mixture of the lithium chloride (LiCl) powder, the aluminum chloride (AlCl₃) powder, and the bismuth fluoride (BiF₃) powder.

3. The sulfur dioxide-based inorganic electrolyte of claim 1, wherein
the lithium chloride (LiCl) powder and a mixture of the aluminum chloride (AlCl₃) powder and the bismuth fluoride (BiF₃) powder have a molar ratio of 1:1.

4. The sulfur dioxide-based inorganic electrolyte of claim 1, wherein a mole number of the lithium chloride (LiCl) powder is greater than each of a mole number of the aluminum chloride (AlCl₃) powder and a mole number of the bismuth fluoride (BiF₃) powder.

5. The sulfur dioxide-based inorganic electrolyte of claim 1, wherein
a mole number of the aluminum chloride (AlCl₃) powder is greater than a mole number of the bismuth fluoride (BiF₃) powder.

6. The sulfur dioxide-based inorganic electrolyte of claim 1, wherein
the aluminum chloride (AlCl₃) powder and the bismuth fluoride (BiF₃) powder have a molar ratio in a range of 9:1 to 6:4.

7. The sulfur dioxide-based inorganic electrolyte of claim 6, wherein
the sulfur dioxide-based inorganic electrolyte has a liquid, gel, or solid phase at room temperature.

8. The sulfur dioxide-based inorganic electrolyte of claim 1, wherein
the aluminum chloride (AlCl₃) powder and the bismuth fluoride (BiF₃) powder have a molar ratio of 9:1 to 8:2.

9. The sulfur dioxide-based inorganic electrolyte of claim 8, wherein
the sulfur dioxide-based inorganic electrolyte has a gel or solid phase at room temperature.

10. The sulfur dioxide-based inorganic electrolyte of claim 1, wherein
the aluminum chloride (AlCl₃) powder and the bismuth fluoride (BiF₃) powder have a molar ratio of 7:3 to 6:4.

11. The sulfur dioxide-based inorganic electrolyte of claim 10, wherein
the sulfur dioxide-based inorganic electrolyte has a gel or solid phase at room temperature.

12. The sulfur dioxide-based inorganic electrolyte of claim 1, wherein
the sulfur dioxide-based inorganic electrolyte has a viscosity of 1 mPa·s to 10⁶ mPa·s at room temperature.

13. A negative electrode for a rechargeable lithium battery, wherein
the negative electrode comprising a sulfur dioxide-based inorganic electrolyte, wherein
the sulfur dioxide-based inorganic electrolyte is prepared by injecting sulfur dioxide (SO₂) gas into an inorganic mixture,
wherein the inorganic mixture comprises
a lithium chloride (LiCl) powder,
an aluminum chloride (AlCl₃) powder, and
a bismuth fluoride (BiF₃) powder.

14. The negative electrode of claim 13, wherein
a mole number of the lithium chloride (LiCl) powder is greater than each of a mole number of the aluminum chloride (AlCl₃) powder and a mole number of the bismuth fluoride (BiF₃) powder.

15. The negative electrode of claim 13, wherein
a mole number of the aluminum chloride (AlCl₃) powder is greater than a mole number of the bismuth fluoride (BiF₃) powder.

16. The negative electrode of claim 13, wherein
the aluminum chloride (AlCl₃) powder and the bismuth fluoride (BiF₃) powder have a molar ratio in a range of 9:1 to 6:4.

17. The negative electrode of claim 16, wherein
the sulfur dioxide-based inorganic electrolyte has a liquid, gel, or solid phase at room temperature.

18. A rechargeable lithium battery comprising a negative electrode comprising a sulfur dioxide-based inorganic electrolyte, wherein
the sulfur dioxide-based inorganic electrolyte is prepared by injecting sulfur dioxide (SO₂) gas into an inorganic mixture,
wherein the inorganic mixture comprises
a lithium chloride (LiCl) powder,
an aluminum chloride (AlCl₃) powder, and
a bismuth fluoride (BiF₃) powder.

19. The rechargeable lithium battery of claim 18, wherein
a mole number of the lithium chloride (LiCl) powder is greater than each of a mole number of the aluminum chloride (AlCl₃) powder and a mole number of the bismuth fluoride (BiF₃) powder.

20. The rechargeable lithium battery of claim 18, wherein
a mole number of the aluminum chloride (AlCl₃) powder is greater than a mole number of the bismuth fluoride (BiF₃) powder.
